(19) United States
(12) Patent Application Publication
(10) Pub. No.: US 2025/0150117 A1
(43) Pub. Date: May 8, 2025

(54) BEAM MANAGEMENT TRIGGERS DUE TO POLARIZATION IMBALANCE WITH UE CASE AND COVER

(71) Applicant: QUALCOMM Incorporated, San Diego, CA (US)

(72) Inventors: Vasanthan RAGHAVAN, West Windsor Township, NJ (US); Sinan ADIBELLI, San Diego, CA (US); Mohammad Ali TASSOUDJI, San Diego, CA (US); Junyi LI, Fairless Hills, PA (US)

(21) Appl. No.: 18/500,748

(22) Filed: Nov. 2, 2023

(51) Int. Cl. H04B 7/00; H04B 7/06

(52) U.S. Cl. CPC H04B 7/002; H04B 7/0617

(57) ABSTRACT

Beam management triggers due to polarization imbalance with UE cases and covers are described. An apparatus is configured to perform a polarization imbalance measurement(s), for a UE external covering or case, of a signal transmission(s). The apparatus is configured to switch to a set of beam weights for communication between the UE and a network node for polarization imbalance mitigation. The apparatus is configured to communicate, with the network node, based on the set of beam weights. Another apparatus is configured to transmit, for a UE, a signal transmission(s) for a polarization imbalance measurement(s) for an external covering or case of the UE. The apparatus is configured to receive, from the UE, a beamforming indication indicative of a request to switch to a set of beam weights for polarization imbalance mitigation. The apparatus is configured to communicate, with the UE, based on the set of beam weights.

### TECHNICAL FIELD

The present disclosure relates generally to communication systems, and more particularly, to wireless communications utilizing beamforming.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at/by a UE. The apparatus is configured to perform at least one polarization imbalance measurement of at least one signal transmission, where the at least one polarization imbalance measurement is associated with an external covering or case of the UE. The apparatus is also configured to switch to a set of beam weights for communication between the UE and a network node for mitigation of a polarization imbalance associated with the at least one polarization imbalance measurement. The apparatus is also configured to communicate, with the network node, based on the set of beam weights.

In the aspect, the method includes performing at least one polarization imbalance measurement of at least one signal transmission, where the at least one polarization imbalance measurement is associated with an external covering or case of the UE. The method also includes switching to a set of beam weights for communication between the UE and a network node for mitigation of a polarization imbalance associated with the at least one polarization imbalance measurement. The method also includes communicating, with the network node, based on the set of beam weights.

In an aspect of the disclosure, a method, a computer-readable medium, and an apparatus are provided. The apparatus is configured to transmit, for a UE, at least one signal transmission for at least one polarization imbalance measurement associated with an external covering or case of the UE. The apparatus is also configured to receive, from the UE, a beamforming indication indicative of a switch to a set of beam weights for mitigation of a polarization imbalance associated with the at least one polarization imbalance measurement. The apparatus is also configured to communicate, with the UE, based on the set of beam weights.

In the aspect, the method includes transmitting, for a UE, at least one signal transmission for at least one polarization imbalance measurement associated with an external covering or case of the UE. The method also includes receiving, from the UE, a beamforming indication indicative of a switch to a set of beam weights for mitigation of a polarization imbalance associated with the at least one polarization imbalance measurement. The method also includes communicating, with the UE, based on the set of beam weights.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of beams and UE covers/cases.

FIG. 5 is a call flow diagram for wireless communications, in accordance with various aspects of the present disclosure.

FIG. 6 is a diagram illustrating example wireless communications and beam weight switching, in accordance with various aspects of the present disclosure.

FIG. 7 is a diagram illustrating example wireless communications and beam weight switching, in accordance with various aspects of the present disclosure.

FIG. 8 is a diagram illustrating example wireless communications and beam weight switching, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network nodes (e.g., base stations, gNBs, etc.) and UEs. For instance, a network node and a UE in a wireless communication network may communicate using beams generated by respective antennas through beamforming. Beams may be formed based on beam weights that act as parameters for phase shifters and amplitude controls of beams. Beam weights may be represented as codebooks, such as fixed-size or finite codebooks, which are small in size and easily stored/implemented.

However, the use of UE cases and/or covers may affect the polarization of transmissions from antennas that would otherwise communicate nominally using beam weights of fixed-size or finite codebooks. Moreover, closing link budgets at frequency range designations FR2-1 (24.25 GHz-52.6 GHZ)/FR3 (7.125 GHz-24.25 GHZ) and beyond frequencies may be accomplished using beamforming at the microwave (RF/IF) level. Analog beamforming codebooks for these frequencies may be designed based on electric field simulations/measurements without use of any UE cases/covers. Such designs may incorporate the impact of UE housing on performance, but no other accessory such as a phone case/cover are incorporated in such studies. In practice, the UEs may be used with a case/cover for cosmetic or practical reasons. These cases/covers cannot be incorporated in codebook design as they are user-specific and can change with time. Further, many variants of UE cases/covers are possible based on different manufacturers (e.g., not all cases/covers are manufactured by or are based on UE original equipment manufacturer (OEM) advice/specifications), cost, material composition/mix, thickness of material, etc. When dual-polarized antennas are used in FR2-1 implementations to double data rates relative to sub-6 GHz systems, the signal strength balance between the two polarizations may be distorted due to the use of a UE case/cover depending on material properties, frequency, angle of interest of the steered beam, and/or the like.

Various aspects relate generally to wireless communications utilizing beamforming. Some aspects more specifically relate to beam management triggers due to polarization imbalance with UE cases/covers. In some examples, measurements of polarization imbalance due to UE cases/covers are performed on reference signals provided by a network node. In some examples, a UE may be configured to switch from an initial set of beam weights (e.g., a finite/fixed codebook that is stored in the radio frequency integrated circuit (RFIC) chip memory) to a set of beam weights geared for communication between the UE and a network node and intended for mitigation of the polarization imbalances that are measured.

Particular aspects of the subject matter described in this disclosure can be implemented to realize one or more of the following potential advantages. In one examples, by measuring polarization imbalances associated with a UE case/cover in operating conditions, the described techniques can be used to provide beam management intervention/mitigation to minimize polarization imbalance. In one example, by adaptively switching a set of beam weights based on polarization imbalance measurements, the described techniques can be used to provide beam management intervention/mitigation across any type of UE case/cover regardless of manufacturer, composition, carrier frequency range of operation, beam properties such as array gain or beamwidth or side lobe level, and/or the like.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

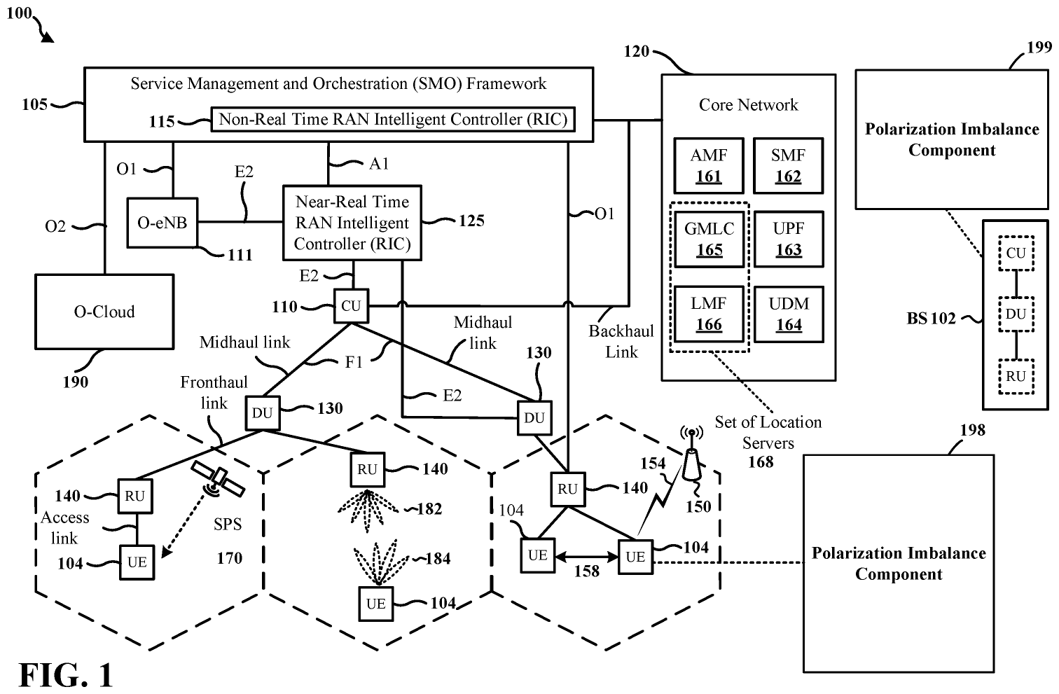

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a polarization imbalance component 198 (“component 198”) that may be configured to perform at least one polarization imbalance measurement of at least one signal transmission, where the at least one polarization imbalance measurement is associated with an external covering or case of the UE. The component 198 may also be configured to switch to a set of beam weights for communication between the UE and a network node for mitigation of a polarization imbalance associated with the at least one polarization imbalance measurement. The component 198 may also be configured to communicate, with the network node, based on the set of beam weights. The component 198 may also be configured to calculate, prior to the switch to the set of beam weights, one or more beam weights of the set of beam weights based on the at least one polarization imbalance measurement. The component 198 may also be configured to transmit, to the network node, a beamforming indication indicative of the set of beam weights for the mitigation of the polarization imbalance associated with the at least one polarization imbalance measurement. The component 198 may also be configured to receive, from the network node and based on the beamforming indication, at least one of a transmission configuration indicator (TCI) state change or a beam switching indication associated with the set of beam weights. The component 198 may also be configured to transmit, to the network node, a signal request for the at least one signal transmission associated with the at least one polarization imbalance measurement. The component 198 may also be configured to receive, from the network node, the at least one signal transmission based on the signal request. The component 198 may also be configured to provide, to the network node, reporting results associated with the switch to the set of beam weights, where the reporting results are indicative of at least one of a polarization imbalance improvement, a two-layer spectral efficiency improvement, or the at least one polarization imbalance measurement. In certain aspects, the base station 102 may have a polarization imbalance component 199 (“component 199”) that may be configured to transmit, for a UE, at least one signal transmission for at least one polarization imbalance measurement associated with an external covering or case of the UE. The component 199 may also be configured to receive, from the UE, a beamforming indication indicative of a switch to a set of beam weights for mitigation of a polarization imbalance associated with the at least one polarization imbalance measurement. The component 199 may also be configured to communicate, with the UE, based on the set of beam weights. The component 199 may also be configured to transmit, for the UE and based on the beamforming indication, at least one of a TCI state change or a beam switching indication associated with the set of beam weights. The component 199 may also be configured to receive, from the UE, a signal request for the at least one signal transmission associated with the at least one polarization imbalance measurement, where transmitting the at least one signal transmission is based on the signal request, where the at least one signal transmission is associated with an initial set of beam weights based on a finite codebook. The component 199 may also be configured to receive, from the UE, reporting results associated with the switch to the set of beam weights, where the reporting results are indicative of at least one of a polarization imbalance improvement, a two-layer spectral efficiency improvement, or the at least one polarization imbalance measurement. Accordingly, the aspects herein for beam management triggers due to polarization imbalance with UE cases/covers provide for measurements of polarization imbalances due to UE cases/covers to be performed on reference signals provided by a network node, where a UE may be configured to switch from an initial set of beam weights (e.g., a finite/fixed codebook) to a set of beam weights for communication between the UE and a network node for mitigation of the polarization imbalances that are measured. Aspects herein provide beam management intervention/mitigation to minimize polarization imbalances by measuring polarization imbalances associated with a UE case/cover in operating conditions, and also provide beam management intervention/mitigation across any type of UE case/cover regardless of manufacturer, composition, carrier frequency range of operation, beam properties, and/or the like, by adaptively switching a set of beam weights based on polarization imbalance measurements.

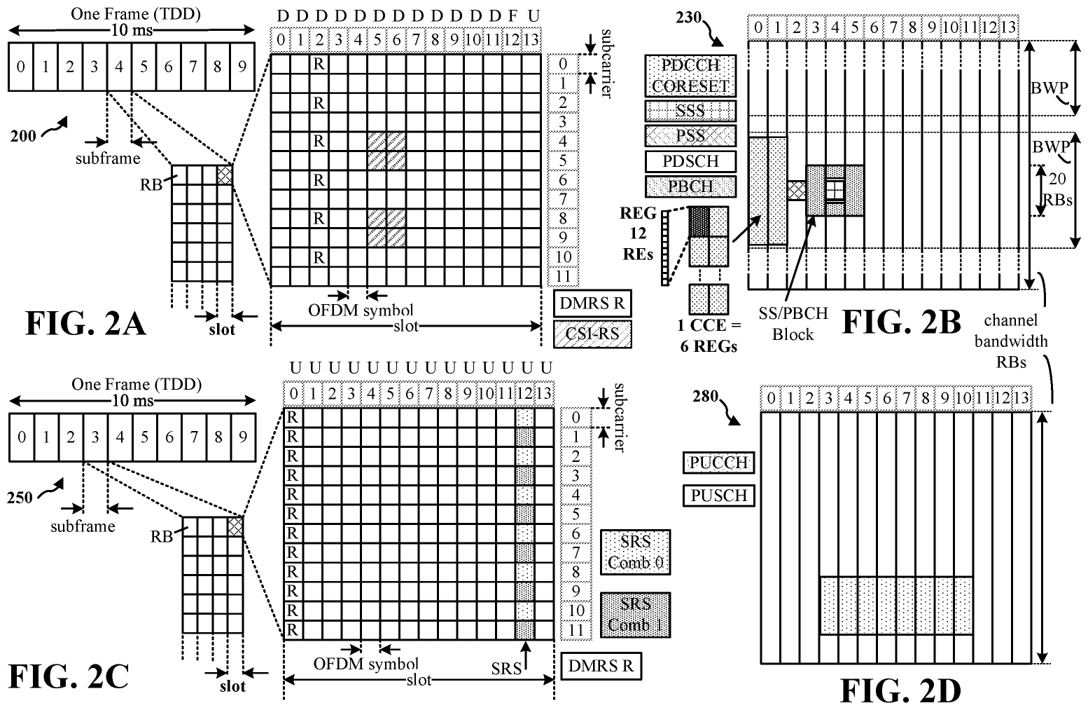

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

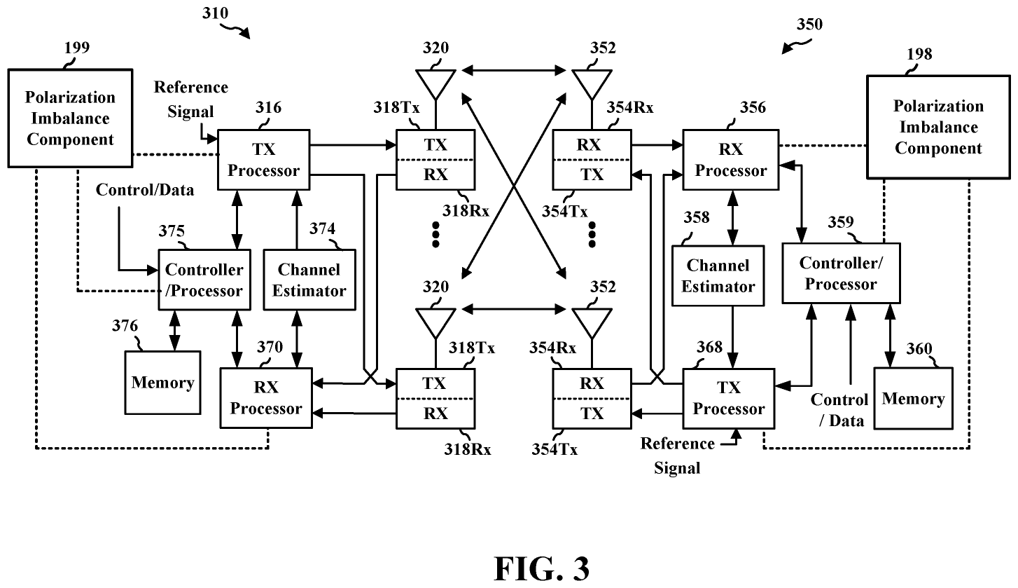

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

The use of UE cases and/or covers may affect the polarization properties of transmissions from antennas that would otherwise communicate nominally using beam weights of fixed-size or finite codebooks. In such nominal communications, it is assumed that the gains seen across polarizations are balanced. Moreover, closing link budgets at FR2-1 (24.25 GHz-52.6 GHz)/FR3 (7.125 GHz-24.25 GHZ) and beyond frequencies may be accomplished using beamforming at the millimeter wave (RF/IF) level. Analog beamforming codebooks for these frequencies may be designed based on electric field simulations/measurements without incorporating or assuming the use of any UE cases/covers. Such designs may incorporate the impact of UE housing on performance. In practice, the UEs may be used with a case/cover for cosmetic or practical reasons. These cases/covers cannot be incorporated in codebook design as they are user-specific and can change with time (albeit on a slow time-scale). Further, many variants of UE cases/covers are possible based on different manufacturers (e.g., not all cases/covers are manufactured by or based on UE OEM advice/specifications), cost, material composition/mix, thickness of material, etc. When dual-polarized antennas are used in FR2-1 implementations to double data rates relative to sub-6 GHz systems, the signal strength balance between the two polarizations may be distorted due to the use of a UE case/cover depending on material properties, frequency, angle of interest of the steered beam, and/or the like.

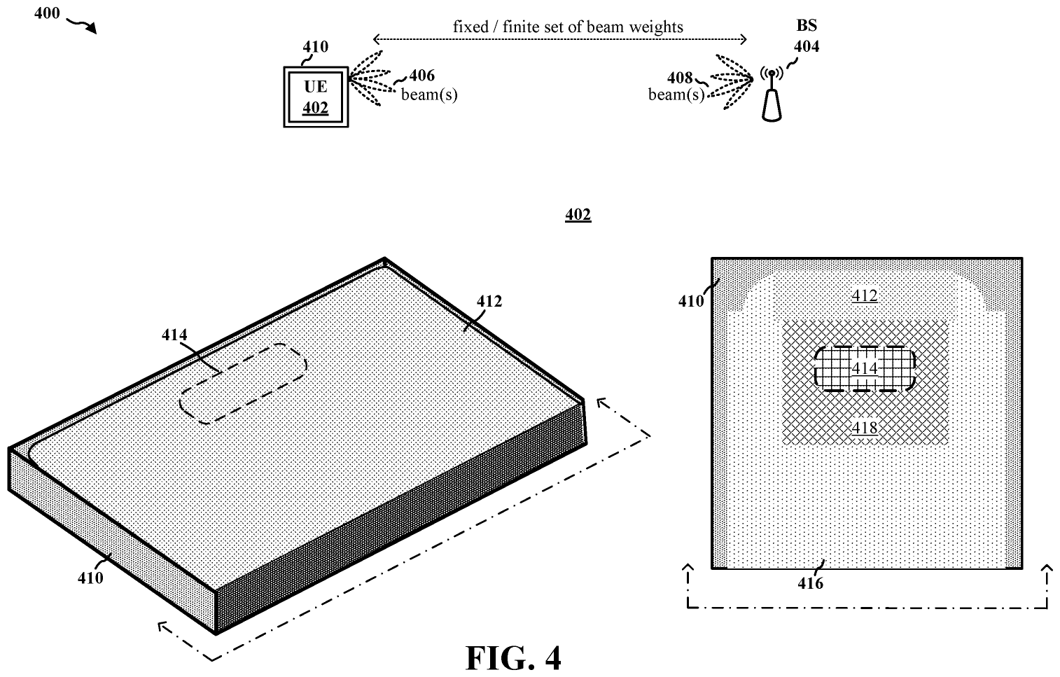

FIG. 4 is a diagram 400 illustrating an example of beams and UE covers/cases. Diagram 400 shows a UE 402 that communicates with a network node (e.g., a base station 404, a gNB, etc.) using beams. UE beams 406 and base station beams 408 are shown, and may be based on a fixed/finite set of beam weights. The UE 402 is shown as having a case/cover 410 thereon. As described herein, an external covering/cover/case of a UE (generally a “case” or a “case/cover”) is a case/cover (e.g., the case/cover 410) in which the UE (e.g., the UE 402) is at least partially encapsulated, where the case/cover is external to a housing (e.g., a UE housing 412, which may also refer to the housing and/or screen/display) of the UE.

As noted, the case/cover 410 may cause polarization imbalances associated with the UE beams 406 of the UE antenna 414 of the UE 402 and/or the base station beams 408 of the base station 404 during communications. Polarization imbalances may include vertical/horizontal imbalances, slant-45 degree/slant-negative 45 degree imbalances, and/or another other pair of orthogonal polarizations. Polarizations may be circular or elliptical or linear. While finite/fixed codebooks for beam weights may be designed to account for UE-specific components and materials, e.g., the dielectric cover of the UE housing 412, adhesive tape, UE components 416, polycarbonate 418, and/or the like.

Common materials of the UE case/cover 410 may include, without limitation, thermoplastic polyurethane (TPU), polycarbonate, silicone, rubber, leather, etc. Dielectric constants of some plastic used for the UE case/cover 410 may vary by manufacturers depending on mix of composites used in manufacturing, etc., but a range of εᵣ=2 to 4 covers most practical scenarios at 28 GHz, and a loss tangent (tan(δ)) of 0.01 may be used to capture approximately how much loss there will be due to use of the UE case/cover 410. However, properties of the case/cover 410 may not be known a priori to account for polarization imbalances caused by its use, and consumers may utilize, or change to, any different type of the UE case/cover 410 at different times.

The aspects herein for beam management triggers due to polarization imbalance with UE cases/covers mitigate imbalances between polarizations. As one example, for 28 GHz operation, two beamforming schemes may be considered: a fixed size-5 codebook based scheme where the beam weights may be stored in RFIC chip memory and an adaptive beam weight based scheme. In scenarios covering 0 dB to 10 dB for antenna array imbalance over a cumulative distribution function (CDF) of 0 to 1, the median and 90th percentile delta between polarizations (or imbalance) can be 2 dB to 4 dB and 4 dB to 9 dB, respectively, while the precise value may depend on parameter settings (e.g., for frequency, thickness of case/cover, dielectric constant of case/cover, etc.). In general, adaptive beam weight based schemes reduce imbalances relative to fixed codebook schemes. For the example above at 28 GHZ, the improvement in imbalance is typically less than 1 dB at the median, however, the improvement can be up to 1.5 dB at the 90th percentile for varying thickness/compositions of case/cover material. Thus, using adaptive beam weights provides improvements for polarization performance over fixed-/finite-sized codebooks.

The aspects herein provide that a UE measure the polarization imbalance with a UE or phone case/cover in operating conditions. Then, using beam management intervention/mitigation (new signal), polarization imbalance is minimized. Without improving the polarization imbalance provided by aspects herein, a UE switches from rank 2 to rank 1. The described aspects show that polarization imbalance can be mitigated via the use of an adaptive set of beam weights.

From the possible hybrid beamforming schemes at the UE side, a finite-sized codebook based beamforming scheme may be utilized for implementations from a complexity consideration perspective. For example, such schemes may use less storage for codebooks/beam weights in RF integrated circuit (RFIC) chip memory, signal strength measurements for beam selections may be directly related to beam usage in data mode, low latency in beam synthesis may be achieved, etc.

The signal strengths observed across polarization layers, however, may be either balanced or imbalanced. In the case of balanced polarizations, signal strength differences across polarizations may be below an appropriately configured (e.g., by network node, base station, gNB) threshold. While in the case of imbalanced polarizations, signal strength differences may be above such a threshold. The degree of imbalance may be a function of a carrier frequency range of operation, UE case/cover properties (e.g., material composition, dielectric constant(s), thickness(es) of material, etc.), UE housing properties, antenna array dimensions, and/or the like. Imbalance may also be a function of a direction of interest (e.g., a steered beam's properties). Thus, imbalance may be a UE-specific property that cannot be pre-determined or known a priori. To determine balance and/or imbalance between polarizations, a UE may measure the signal strength estimates across polarization layers, and whether the network node can assume balanced or imbalanced polarizations at the UE may depend on UE measurements and/or reports. Accordingly, without implementation of the aspects herein for beam management triggers due to polarization imbalance with UE cases/covers, a UE might switch from rank-2 to rank-1 and experience performance degradation.

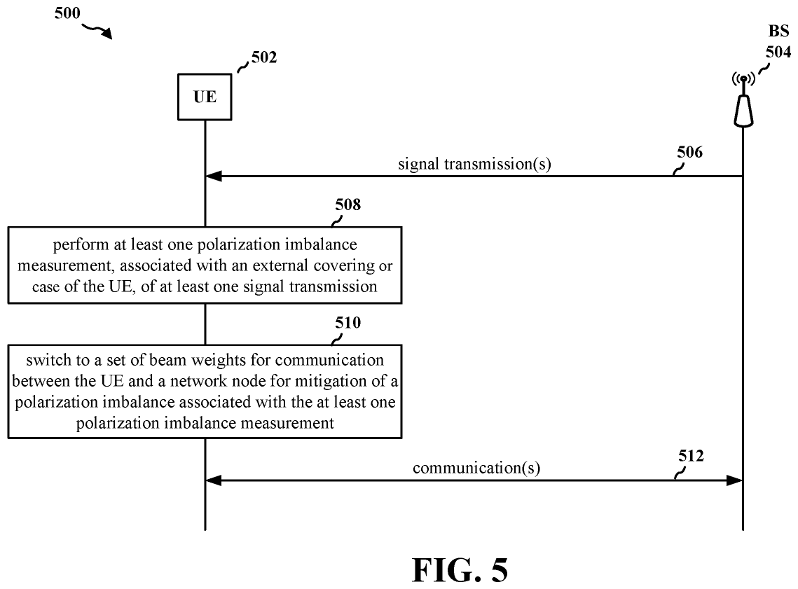

FIG. 5 is a call flow diagram 500 for wireless communications, in various aspects. Call flow diagram 500 illustrates beam management triggers due to polarization imbalance with UE cases/covers for a wireless device (a UE 502, by way of example) that communicates (e.g., using a communication(s) 512) with the network node (a base station 504, such as a gNB or other type of base station, by way of example, as shown), in various aspects. Aspects described for the base station 504 may be performed by the base station in aggregated form and/or by one or more components of the base station in disaggregated form. Additionally, or alternatively, the aspects may be performed by the UE 502 autonomously, in addition to, and/or in lieu of, operations of the base station 504.

In the illustrated aspect, the UE 502 may be configured to receive, and the base station 504 may be configured to transmit/provide, signal transmissions(s) 506. In aspects, the signal transmissions(s) 506 may be or include one or more reference signals. The polarization imbalance measurement(s) for polarization imbalances described herein may be associated with a signal strength difference across orthogonal polarizations (e.g., a horizontal polarization and a vertical polarization) of the signal transmissions(s) 506, e.g., over one or more of the reference signals. In aspects, the UE 502 may be configured to transmit, and the network node (e.g., the base station 504) may be configured to receive, a signal request for the signal transmission(s) 506 associated with the at least one polarization imbalance measurement. Based on such a signal request, the UE 502 may be configured to receive, and the network node (e.g., the base station 504) may be configured to provide/transmit, the signal transmission(s) 506. In some aspects, the signal transmission(s) may be associated with an initial set of beam weights based on a finite/fixed codebook.

The UE 502 may be configured to perform (at 508) at least one polarization imbalance measurement, associated with an external covering or case of the UE 502, of a signal transmission(s) 506. That is, the UE 502 may be configured to perform (at 508) at least one polarization imbalance measurement of at least one signal transmission, where the at least one polarization imbalance measurement is associated with an external covering/case of the UE 502. In aspects, the at least one polarization imbalance measurement performed (at 508) may be based on at least one of a material composition of the external covering or case, a dielectric constant of the external covering or case, a material thickness of the external covering or case, a carrier frequency range of operation, a set of housing properties of the UE 502, a UE antenna array dimension, inter-antenna element spacings at the UE 502, one or more steered beam properties, or a direction of interest associated with beamforming.

The UE 502 may be configured to switch (at 510) to a set of beam weights for communication between the UE 502 and a network node (e.g., the base station 504) for mitigation of a polarization imbalance associated with the at least one polarization imbalance measurement. In aspects, the set of beam weights may include at least one of a first beam weight associated with a first polarization (e.g., a horizontal, a slant 45-degree polarization, etc.) or a second beam weight associated with a second polarization that is orthogonal to the first polarization (e.g., a vertical, a slant negative 45-degree polarization, etc.). In aspects, at least one of the first beam weight or the second beam weight may be associated with a UE beam of the UE 502 that corresponds to a respective network node beam of the network node (e.g., the base station 504 for the communication(s) 512). In aspects, to switch (at 510) to the set of beam weights, the UE may be configured to calculate, e.g., prior to the switch (at 510) to the set of beam weights, one or more beam weights of the set of beam weights based on the at least one polarization imbalance measurement performed (at 508). In aspects, UE 502 may base the switch (at 510) to the set of beam weights on a comparison of the at least one polarization imbalance measurement to an imbalance threshold condition, and/or on a UE 502 beamforming configuration indicative of switching to the set of beam weights from an initial set of beam weights associated with the signal transmission(s) 506.

Prior to, at least partially concurrently with, or subsequent to the switch (at 510), the UE 502 may be configured to transmit, and the network node the (e.g., the base station 504) may be configured to receive, a beamforming indication indicative of a switch to and/or a request to switch to the set of beam weights for the mitigation of the polarization imbalance associated with the at least one polarization imbalance measurement. Based on the beamforming indication, the UE 502 may be configured to receive, and the network node (e.g., the base station 504) may be configured to transmit, at least one of a transmission configuration indicator (TCI) state change or a beam switching indication associated with the set of beam weights.

Accordingly, the UE 502 may be configured to trigger to the network node (e.g., the base station 504, a gNB, etc.) a beamforming scheme switch (e.g., the switch (at 510) to the set of beam weights) to enable the mitigation of polarization imbalance(s) due to the use of a case/cover attachment with the UE 502. In aspects, the trigger signaling (e.g., the beamforming indication indicative of a switch to and/or a request to switch to the set of beam weights for the mitigation of a polarization imbalance associated with the at least one polarization imbalance measurement) may be based on an indication of an observed imbalance (e.g., the polarization imbalance measurement(s) performed (at 508). In some other aspects, the network node (e.g., the base station 504, a gNB, etc.) may configure the UE 502 with an allowed imbalance signal strength threshold and the UE 502 may be configured to indicate a beamforming switch by comparing observed polarization imbalance measurements (e.g., at 508) with the threshold.

The UE 502 may be configured to communicate or receive/transmit the communication(s) 512, with the network node (e.g., the base station 504), based on the set of beam weights that are switched to (at 508). Likewise, the network node (e.g., the base station 504) may be configured to communicate or receive/transmit the communication(s) 512, with the UE 502, based on the set of beam weights that are switched to (at 508). In some aspects, UE 502 may be configured to provide/transmit, and the network node (e.g., the base station 504) may be configured to receive, reporting results associated with the switch (at 510) to the set of beam weights. Such reporting results may be indicative of at least one of a polarization imbalance improvement, a two-layer spectral efficiency improvement, other key performance indicators (KPIs), the at least one polarization imbalance measurement, and/or the like.

Accordingly, in some aspects, if the UE 502 has balanced polarizations, or returns from unbalanced to balanced polarizations, based on the polarization imbalance measurement(s) performed (at 508), the UE 502 may continue to use an initial finite-sized codebook based beamforming scheme. In such aspects, if the UE 502 has imbalanced polarizations based on the polarization imbalance measurement(s) performed (at 508), the UE 502 may be configured to implement an improved beamforming scheme such as those based on adaptive/dynamic beam weights to mitigate imbalances. Thus, to mitigate imbalance across polarization layers, the UE 502 may be configured to switch (at 510) to a beamforming scheme, e.g., to a set of beam weights, for the communication(s) 512 with the base station 504. This switch (at 510) in beamforming scheme may include signaling from the UE 502 to the network node (e.g., the base station 504, a gNB, etc.) as network node-assisted beam synthesis for adaptive/dynamic beam weights may utilize reference signal configurations/grants, possible TCI state changes, UE 502 beam switching, and/or the like.

In some aspects, the UE 502 may be configured to indicate, to the base station 504, a rank information (RI) switch from rank-2 to rank-1. Such a switch for the RI may be performed under an assumption that the UE 502 may not be configured to mitigate polarization imbalances at all. As noted above, however, the UE 502 may be configured for mitigation of polarization imbalances using at switch to an adaptive set of beam weights. Thus, a RI=2 solution may be utilized based on the analog beamforming weights adapted to the case/cover distortions and the signaling described in the aspects herein for beam management triggers due to polarization imbalance with UE cases/covers.

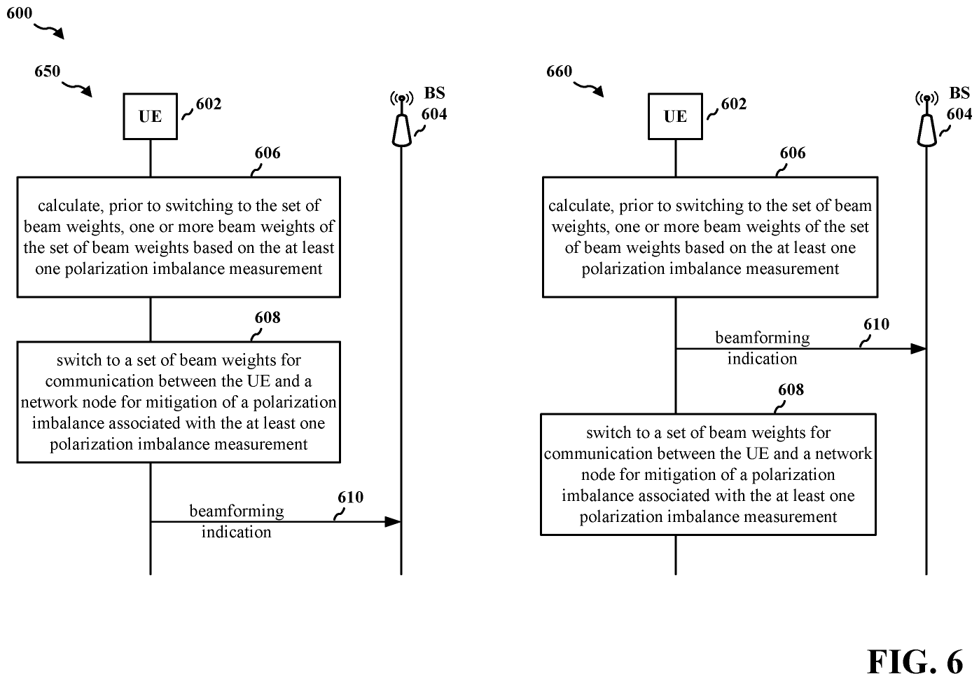

FIG. 6 is a diagram 600 illustrating example wireless communications and beam weight switching, in various aspects. The diagram 600 shows a configuration 650 and a configuration 660 for wireless communications and beam weight switching in the context of a UE 602 and a base station 604 (e.g., a network node, gNB, etc.). The diagram 600 may include further aspects of the call flow diagram 500 in FIG. 5, as described above.

As one example, in the configuration 650, the UE 602 may be configured to calculate (at 606), prior to switching to the set of beam weights, one or more beam weights of the set of beam weights based on the at least one polarization imbalance measurement. As noted above for FIG. 5, a UE may be configured to perform such a calculation as part of the switch (at 510) to the set of beam weights, and prior to an actual switch (at 510) to the set of beam weights, based on the one or more beam weights of the set of beam weights based on the at least one polarization imbalance measurement performed (at 508). The UE 602 may also be configured to switch (at 608) to a set of beam weights for communication between the UE 602 and a network node (e.g., the base station 604) for mitigation of a polarization imbalance associated with the at least one polarization imbalance measurement, as similarly described above for FIG. 5 in the context of the switch (at 510). Subsequent to the switch (at 608), the UE 602 may be configured to provide/transmit, and the base station 604 may be configured to receive, a beamforming indication 610 indicative of a switch to and/or a request to switch to the set of beam weights for the mitigation of the polarization imbalance associated with the at least one polarization imbalance measurement. After the providing/transmitting the beamforming indication 610, the UE 602 may be configured to communicate with the base station 604, as described herein.

As one example, in the configuration 660, the UE 602 may be configured to calculate (at 606), prior to switching to the set of beam weights, one or more beam weights of the set of beam weights based on the at least one polarization imbalance measurement, as described above. That is, with respect to FIG. 5, a UE may be configured to perform such a calculation as part of the switch (at 510) to the set of beam weights, and prior to an actual switch (at 510) to the set of beam weights, based on the one or more beam weights of the set of beam weights based on the at least one polarization imbalance measurement performed (at 508). In contrast to the configuration 650, and prior to the switch (at 608), the UE 602 may be configured to provide/transmit, and the base station 604 may be configured to receive, the beamforming indication 610 indicative of a switch to and/or a request to switch to the set of beam weights for the mitigation of the polarization imbalance associated with the at least one polarization imbalance measurement. In such aspects, the UE 602 may then be configured to switch (at 608) to the set of beam weights for communication between the UE 602 and a network node (e.g., the base station 604) for mitigation of the polarization imbalance associated with the at least one polarization imbalance measurement, as similarly described above for FIG. 5 in the context of the switch (at 510). After the switch (at 608) the UE 602 may be configured to communicate with the base station 604, as described herein.

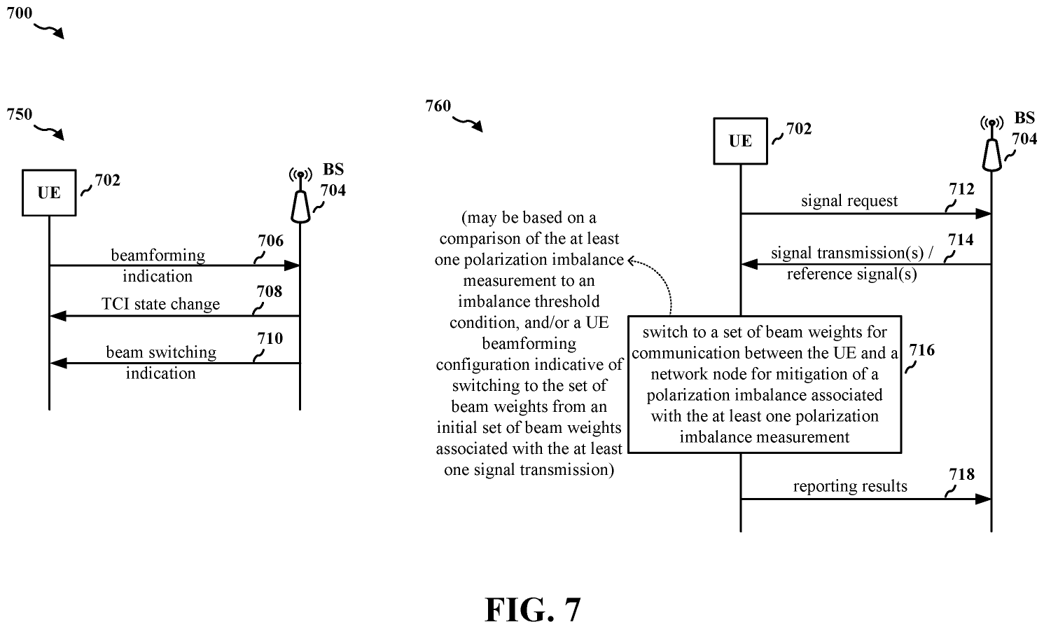

FIG. 7 is a diagram 700 illustrating example wireless communications and beam weight switching, in various aspects. The diagram 700 shows a configuration 750 and a configuration 760 for wireless communications and beam weight switching in the context of a UE 702 and a base station 704 (e.g., a network node, gNB, etc.). The diagram 700 may include further aspects of the call flow diagram 500 in FIG. 5, the configuration 650 in FIG. 6, and/or the configuration 660 in FIG. 6, as described above.

As one example, in the configuration 750, the UE 702 may be configured to provide/transmit, and the base station 704 may be configured to receive, a beamforming indication 706 indicative of a switch to and/or a request to switch and/or a request to switch to the set of beam weights for the mitigation of the polarization imbalance associated with the at least one polarization imbalance measurement. The beamforming indication 706 may be an aspect of the beamforming indication 610 described above for FIG. 6. Based on the beamforming indication 706, the UE 702 may be configured to receive, and the base station 704 may be configured to provide/transmit, a TCI state change indication 708 and/or a beam switching indication 710 that is associated with the set of beam weights. In some aspects, the TCI state change indication 708 and the beam switching indication 710 may be provided in the same or in separate signaling. The TCI state change indication 708 and/or the beam switching indication 710 may be associated with a switch (e.g., at 510 in FIG. 5; at 608 in FIG. 6) to a set of beam weights for communication between the UE 702 and the network node (e.g., the base station 704) for mitigation of a polarization imbalance associated with at least one polarization imbalance measurement.

In the configuration 760, the UE 702 may be configured to provide/transmit, and the base station 704 may be configured to receive, a signal request 712 for the at least one signal transmission 714 (e.g., 506 in FIG. 5) associated with the at least one polarization imbalance measurement (e.g., performed at 508 in FIG. 5). The UE 702 may be configured to receive, and the base station 704 may be configured to provide/transmit, e.g., in response to and/or based on the signal request 712, the at least one signal transmission 714. In aspects, as noted herein, the at least one signal transmission 714 may include one or more reference signals on which the UE 702 may be configured to calculate (e.g., at 508 in FIG. 5; at 606 in FIG. 6) one or more beam weights of the set of beam weights based on the at least one polarization imbalance measurement. The UE 702 may be configured to switch (at 716) to a set of beam weights for communication between the UE 702 and a network node (e.g., the base station 704) for mitigation of a polarization imbalance associated with the at least one polarization imbalance measurement, as similarly described above with respect to FIGS. 5, 6.

In aspects, the switch (at 716) may be based on a comparison of the at least one polarization imbalance measurement to an imbalance threshold condition (e.g., an allowed imbalance signal strength threshold), and/or a UE 702 beamforming configuration indicative of switching (at 716) to the set of beam weights from an initial set of beam weights (e.g., a fixed or finite codebook) associated with the at least one signal transmission. Subsequently, the UE 702 and the base station 704 may be configured to communicate based on the set of beam weights, as noted herein. Additionally, the UE 702 may be configured to provide/transmit, and the base station 704 may be configured to receive, reporting results 718, such as reporting results associated with the switch (at 716) to the set of beam weights by the UE 702, where the reporting results are indicative of at least one of a polarization imbalance improvement, a two-layer spectral efficiency improvement, other key performance indicators (KPIs), the at least one polarization imbalance measurement, and/or the like.

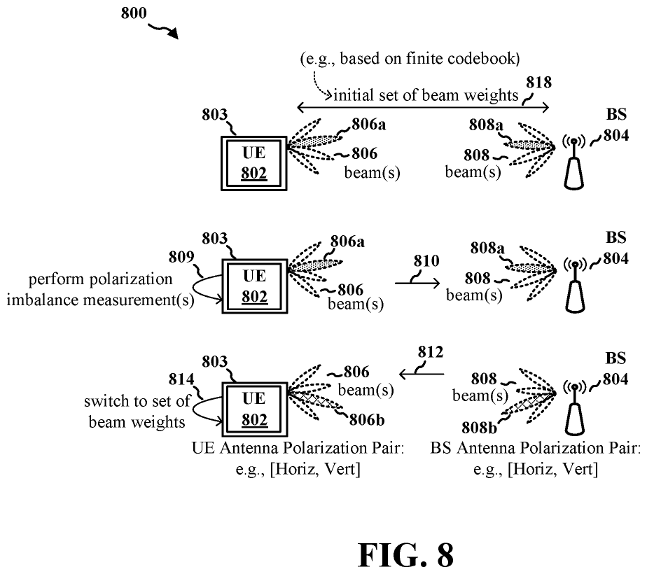

FIG. 8 is a diagram 800 illustrating example wireless communications and beam weight switching, in various aspects. The diagram 800 shows an example configuration for wireless communications and beam weight switching in the context of a UE 802 and a base station 804 (e.g., a network node, gNB, etc.). The diagram 800 may include further aspects of the call flow diagram 500 in FIG. 5, the configuration 650 in FIG. 6, the configuration 660 in FIG. 6, the configuration 750 in FIG. 7, and/or the configuration 760 in FIG. 7, as described above.

The UE 802 and the base station 804 may be configured to communicate with each other using beams: UE beams 806 and base station beams 808, as shown by way of example. Initially, for communications, the UE 802 and the base station 804 may be configured to communicate based on an initial set of beam weights 818 for a fixed/finite codebook or set of beam weights. When the UE 802 has a case/cover 803 thereon, such a case/cover 803 may cause polarization imbalances, as described herein, associated with the UE beams 806 of the antenna of the UE 802 and/or the base station beams 808 of the antennas of the base station 804 during communications (e.g., for a utilized beam 806a of the UE 802 and an initial beam 808a of the base station 804). As noted, polarization imbalances may include vertical/horizontal imbalances, slant-45 degree/slant-negative 45 degree imbalances, and/or another other pair of orthogonal polarizations, and while the finite/fixed codebook for the initial set of beam weights 818 may be designed to account for UE-specific components and materials, e.g., the dielectric cover of the UE 802 housing, adhesive tape, polycarbonate materials, and/or the like, finite/fixed codebooks may not account for case/cover 803 variations and properties. The UE 802 may be configured to perform a polarization imbalance measurement(s), of at least one signal transmission as described herein, associated with its external covering or case (e.g., the case/cover 803). The UE 802 may be configured to transmit/provide, and the base station 804 may be configured to receive, a beamforming indication 810 indicative of a switch to and/or a request to switch to a switch to and/or a request to switch to a set of beam weights for the mitigation of the at least one polarization imbalance measurement, and based on the beamforming indication 810, the UE 802 may be configured to receive, and the base station 804 may be configured to provide/transmit, a transmission 812 indicative of a TCI state change indication and/or a beam switching indication that is associated with the set of beam weights. The UE 802 may be configured to switch (at 814) to the set of beam weights and communication with the base station 804 based thereon (e.g., based on a beam 806b of the UE beams 806 and a beam 808b of the base station beams 808 associated with the set of beam weights.

Accordingly, the aspects herein for beam management triggers due to polarization imbalance with UE cases/covers mitigate imbalances between polarizations.

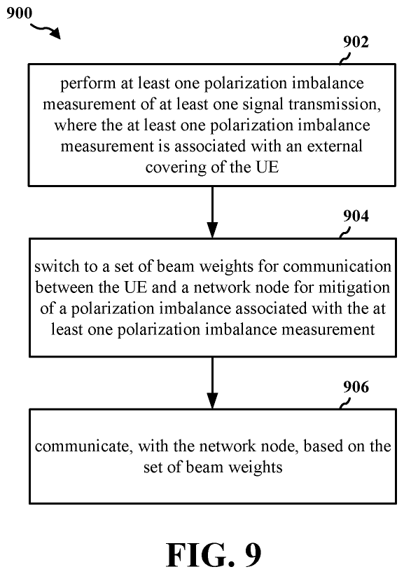

FIG. 9 is a flowchart 900 of a method of wireless communication. The method may be performed by a UE (e.g., the UE 104, 402, 502, 602, 702, 802; the apparatus 1104). In some aspects, the method may include aspects described in connection with the communication flow in FIG. 5 and/or aspects described in FIGS. 4, 6, 7, 8. The method may be for beam management triggers due to polarization imbalance with UE cases/covers. The method may provide for beam management intervention/mitigation to minimize polarization imbalances by measuring polarization imbalances associated with a UE case/cover in operating conditions, and also provide for beam management intervention/mitigation across any type of UE case/cover regardless of manufacturer, composition, carrier frequency range of operation, beam properties, and/or the like, by adaptively switching a set of beam weights based on polarization imbalance measurements.

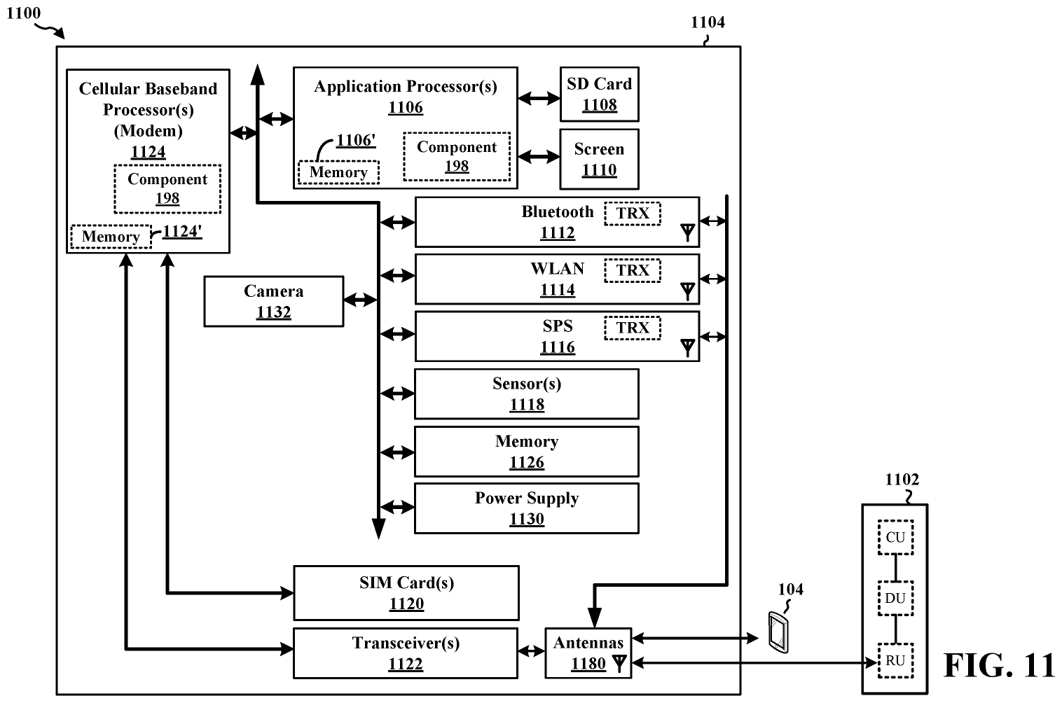

In 902, the UE performs at least one polarization imbalance measurement of at least one signal transmission, where the at least one polarization imbalance measurement is associated with an external covering of the UE. As an example, the measurement may be performed by one or more of the component 198, the transceiver(s) 1122, and/or the antenna 1180 in FIG. 11. FIG. 5 illustrates, in context of FIGS. 4 and 6-8, an example of the UE 502 performing such measurement on a transmission(s) from a network node (e.g., the base station 504).

The UE 502 may be configured to receive, and the base station 504 may be configured to transmit/provide, signal transmissions(s) 506 (e.g., 714 in FIG. 7). In aspects, the signal transmissions(s) 506 (e.g., 714 in FIG. 7) may be or include one or more reference signals. The polarization imbalance measurement(s) for polarization imbalances described herein may be associated with a signal strength difference across orthogonal polarizations (e.g., a horizontal polarization and a vertical polarization) of the signal transmissions(s) 506 (e.g., 714 in FIG. 7), e.g., over one or more of the reference signals. In aspects, the UE 502 may be configured to transmit, and the network node (e.g., the base station 504) may be configured to receive, a signal request (e.g., 712 in FIG. 7) for the signal transmission(s) 506 (e.g., 714 in FIG. 7) associated with the at least one polarization imbalance measurement. Based on such a signal request (e.g., 712 in FIG. 7), the UE 502 may be configured to receive, and the network node (e.g., the base station 504) may be configured to provide/transmit, the signal transmission(s) 506 (e.g., 714 in FIG. 7). In some aspects, the signal transmission(s) (e.g., 714 in FIG. 7) may be associated with an initial set of beam weights based on a finite/fixed codebook.

The UE 502 may be configured to perform (at 508) (e.g., 809 in FIG. 8) at least one polarization imbalance measurement, associated with an external covering or case (e.g., 410 in FIG. 4; 803 in FIG. 8) of the UE 502, of a signal transmission(s) 506. That is, the UE 502 may be configured to perform (at 508) (e.g., 809 in FIG. 8) at least one polarization imbalance measurement of at least one signal transmission, where the at least one polarization imbalance measurement is associated with an external covering/case (e.g., 410 in FIG. 4; 803 in FIG. 8) of the UE 502. In aspects, the at least one polarization imbalance measurement performed (at 508) (e.g., 809 in FIG. 8) may be based on at least one of a material composition of the external covering or case (e.g., 410 in FIG. 4; 803 in FIG. 8), a dielectric constant of the external covering or case (e.g., 410 in FIG. 4; 803 in FIG. 8), a material thickness of the external covering or case (e.g., 410 in FIG. 4; 803 in FIG. 8), a carrier frequency range of operation, a set of housing properties of the UE 502, a UE antenna array dimension, inter-antenna element spacings at the UE 502, one or more steered beam properties, or a direction of interest associated with beamforming.

In 904, the UE switches to a set of beam weights for communication between the UE and a network node for mitigation of a polarization imbalance associated with the at least one polarization imbalance measurement. As an example, the switch may be performed by one or more of the component 198, the transceiver(s) 1122, and/or the antenna 1180 in FIG. 11. FIG. 5 illustrates, in context of FIGS. 4 and 6-8, an example of the UE 502 performing such switching.

The UE 502 may be configured to switch (at 510) (e.g., 606, 608 in FIG. 6; 716 in FIG. 7; 814 in FIG. 8) to a set of beam weights for communication between the UE 502 and a network node (e.g., the base station 504) for mitigation of a polarization imbalance associated with the at least one polarization imbalance measurement. In aspects, the set of beam weights may include at least one of a first beam weight associated with a first polarization (e.g., a horizontal, a slant 45-degree polarization, etc.) or a second beam weight associated with a second polarization that is orthogonal to the first polarization (e.g., a vertical, a slant negative 45-degree polarization, etc.). In aspects, at least one of the first beam weight or the second beam weight may be associated with a UE beam of the UE 502 that corresponds to a respective network node beam of the network node (e.g., the base station 504 for the communication(s) 512). In aspects, to switch (at 510) (e.g., 606, 608 in FIG. 6; 716 in FIG. 7; 814 in FIG. 8) to the set of beam weights, the UE may be configured to calculate (e.g., 606 in FIG. 6), e.g., prior to the switch (at 510) (e.g., 606, 608 in FIG. 6; 716 in FIG. 7; 814 in FIG. 8) to the set of beam weights, one or more beam weights of the set of beam weights based on the at least one polarization imbalance measurement performed (at 508) (e.g., 809 in FIG. 8). In aspects, UE 502 may base the switch (at 510) (e.g., 606, 608 in FIG. 6; 716 in FIG. 7; 814 in FIG. 8) to the set of beam weights on a comparison of the at least one polarization imbalance measurement to an imbalance threshold condition, and/or on a UE 502 beamforming configuration indicative of switching to the set of beam weights from an initial set of beam weights associated with the signal transmission(s) 506 (e.g., 714 in FIG. 7).

Prior to, at least partially concurrently with, or subsequent to the switch (at 510) (e.g., 606, 608 in FIG. 6; 716 in FIG. 7; 814 in FIG. 8), the UE 502 may be configured to transmit, and the network node the (e.g., the base station 504) may be configured to receive, a beamforming indication (e.g., 610 in FIG. 6; 706 in FIG. 7; 810 in FIG. 8) indicative of a switch to and/or a request to switch to the set of beam weights for the mitigation of the polarization imbalance associated with the at least one polarization imbalance measurement. Based on the beamforming indication (e.g., 610 in FIG. 6; 706 in FIG. 7; 810 in FIG. 8), the UE 502 may be configured to receive, and the network node (e.g., the base station 504) may be configured to transmit, at least one of a TCI state change (e.g., 708 in FIG. 7; 812 in FIG. 8) or a beam switching indication (e.g., 710 in FIG. 7; 812 in FIG. 8) associated with the set of beam weights. Accordingly, the UE 502 may be configured to trigger to the network node (e.g., the base station 504, a gNB, etc.) a beamforming scheme switch (e.g., the switch (at 510) (e.g., 606, 608 in FIG. 6; 716 in FIG. 7; 814 in FIG. 8) to the set of beam weights) to enable the mitigation of polarization imbalance(s) due to the use of a case/cover (e.g., 410 in FIG. 4; 803 in FIG. 8) attachment with the UE 502. In aspects, the trigger signaling (e.g., the beamforming indication (e.g., 610 in FIG. 6; 706 in FIG. 7; 810 in FIG. 8) indicative of a switch to and/or a request to switch to the set of beam weights for the mitigation of the polarization imbalance associated with the at least one polarization imbalance measurement) may be based on an indication of an observed imbalance (e.g., the polarization imbalance measurement(s) performed (at 508) (e.g., 809 in FIG. 8). In some other aspects, the network node (e.g., the base station 504, a gNB, etc.) may configure the UE 502 with an allowed imbalance signal strength threshold and the UE 502 may be configured to indicate a beamforming switch by comparing observed polarization imbalance measurements (e.g., at 508) (e.g., 809 in FIG. 8) with the threshold.

In 906, the UE communicates, with the network node, based on the set of beam weights. As an example, the communication may be performed by one or more of the component 198, the transceiver(s) 1122, and/or the antenna 1180 in FIG. 11. FIG. 5 illustrates, in context of FIGS. 4 and 6-8, an example of the UE 502 so communicating such with a network node (e.g., the base station 504).

The UE 502 may be configured to communicate or receive/transmit the communication(s) 512, with the network node (e.g., the base station 504), based on the set of beam weights that are switched to (at 508) (e.g., 809 in FIG. 8). Likewise, the network node (e.g., the base station 504) may be configured to communicate or receive/transmit the communication(s) 512, with the UE 502, based on the set of beam weights that are switched to (at 508) (e.g., 809 in FIG. 8). In some aspects, UE 502 may be configured to provide/transmit, and the network node (e.g., the base station 504) may be configured to receive, reporting results (e.g., 718 in FIG. 7) associated with the switch (at 510) (e.g., 606, 608 in FIG. 6; 716 in FIG. 7; 814 in FIG. 8) to the set of beam weights. Such reporting results (e.g., 718 in FIG. 7) may be indicative of at least one of a polarization imbalance improvement, a two-layer spectral efficiency improvement, other key performance indicators (KPIs), the at least one polarization imbalance measurement, and/or the like.

Accordingly, in some aspects, if the UE 502 has balanced polarizations, or returns from unbalanced to balanced polarizations, based on the polarization imbalance measurement(s) performed (at 508) (e.g., 809 in FIG. 8), the UE 502 may continue to use an initial finite-sized codebook based beamforming scheme. In such aspects, if the UE 502 has imbalanced polarizations based on the polarization imbalance measurement(s) performed (at 508) (e.g., 809 in FIG. 8), the UE 502 may be configured to implement an improved beamforming scheme such as those based on adaptive/dynamic beam weights to mitigate imbalances. Thus, to mitigate imbalance across polarization layers, the UE 502 may be configured to switch (at 510) (e.g., 606, 608 in FIG. 6; 716 in FIG. 7; 814 in FIG. 8) to a beamforming scheme, e.g., to a set of beam weights, for the communication(s) 512 with the base station 504. This switch (at 510) (e.g., 606, 608 in FIG. 6; 716 in FIG. 7; 814 in FIG. 8) in beamforming scheme may include signaling from the UE 502 to the network node (e.g., the base station 504, a gNB, etc.) as network node-assisted beam synthesis for adaptive/dynamic beam weights may utilize reference signal configurations/grants, possible TCI state changes (e.g., 708 in FIG. 7; 812 in FIG. 8), UE 502 beam switching (e.g., 710 in FIG. 7; 812 in FIG. 8), and/or the like.

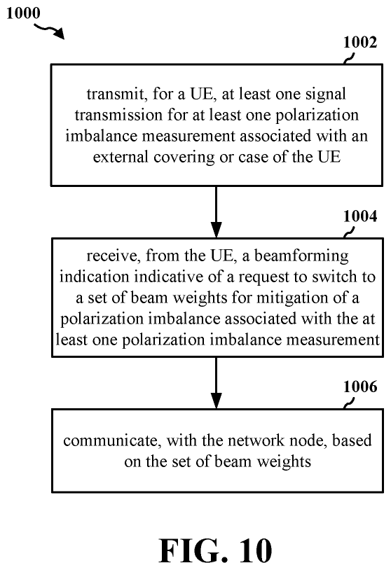

FIG. 10 is a flowchart 1000 of a method of wireless communication. The method may be performed by a base station (e.g., the base station 102, 404, 504, 604, 704, 804; the network entity 1102, 1202, 1260). In some aspects, the method may include aspects described in connection with the communication flow in FIG. 5 and/or aspects described in FIGS. 4, 6, 7, 8. The method may be for beam management triggers due to polarization imbalance with UE cases/covers. The method may provide for beam management intervention/mitigation to minimize polarization imbalances by measuring polarization imbalances associated with a UE case/cover in operating conditions, and also provide for beam management intervention/mitigation across any type of UE case/cover regardless of manufacturer, composition, carrier frequency range of operation, beam properties, and/or the like, by adaptively switching a set of beam weights based on polarization imbalance measurements.

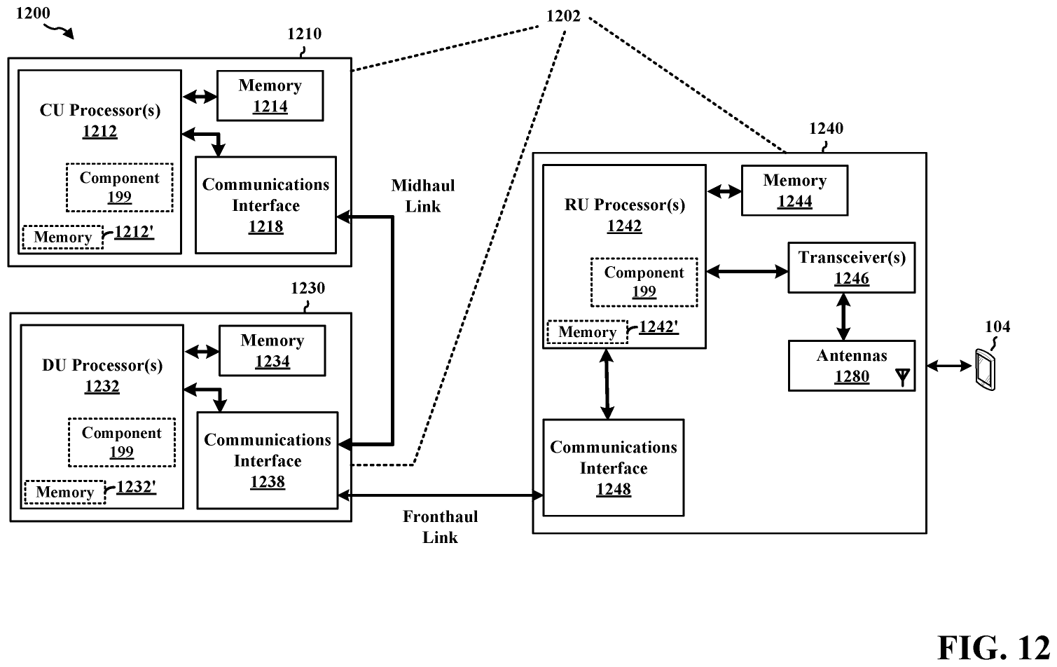

In 1002, the network node transmits, for a UE, at least one signal transmission for at least one polarization imbalance measurement associated with an external covering of the UE. As an example, the transmission may be performed by one or more of the component 199, the transceiver(s) 1246, and/or the antenna 1280 in FIG. 12. FIG. 5 illustrates, in context of FIGS. 4 and 6-8, an example of a network node (e.g., the base station 504) transmitting such signal transmission(s) for a UE (e.g., the UE 502).

The UE 502 may be configured to receive, and the base station 504 may be configured to transmit/provide, signal transmissions(s) 506 (e.g., 714 in FIG. 7). In aspects, the signal transmissions(s) 506 (e.g., 714 in FIG. 7) may be or include one or more reference signals. The polarization imbalance measurement(s) for polarization imbalances described herein may be associated with a signal strength difference across orthogonal polarizations (e.g., a horizontal polarization and a vertical polarization) of the signal transmissions(s) 506 (e.g., 714 in FIG. 7), e.g., over one or more of the reference signals. In aspects, the UE 502 may be configured to transmit, and the network node (e.g., the base station 504) may be configured to receive, a signal request (e.g., 712 in FIG. 7) for the signal transmission(s) 506 (e.g., 714 in FIG. 7) associated with the at least one polarization imbalance measurement. Based on such a signal request (e.g., 712 in FIG. 7), the UE 502 may be configured to receive, and the network node (e.g., the base station 504) may be configured to provide/transmit, the signal transmission(s) 506 (e.g., 714 in FIG. 7). In some aspects, the signal transmission(s) (e.g., 714 in FIG. 7) may be associated with an initial set of beam weights based on a finite/fixed codebook.

The UE 502 may be configured to perform (at 508) (e.g., 809 in FIG. 8) at least one polarization imbalance measurement, associated with an external covering or case (e.g., 410 in FIG. 4; 803 in FIG. 8) of the UE 502, of a signal transmission(s) 506. That is, the UE 502 may be configured to perform (at 508) (e.g., 809 in FIG. 8) at least one polarization imbalance measurement of at least one signal transmission, where the at least one polarization imbalance measurement is associated with an external covering/case (e.g., 410 in FIG. 4; 803 in FIG. 8) of the UE 502. In aspects, the at least one polarization imbalance measurement performed (at 508) (e.g., 809 in FIG. 8) may be based on at least one of a material composition of the external covering or case (e.g., 410 in FIG. 4; 803 in FIG. 8), a dielectric constant of the external covering or case (e.g., 410 in FIG. 4; 803 in FIG. 8), a material thickness of the external covering or case (e.g., 410 in FIG. 4; 803 in FIG. 8), a carrier frequency range of operation, a set of housing properties of the UE 502, a UE antenna array dimension, inter-antenna element spacings at the UE 502, one or more steered beam properties, or a direction of interest associated with beamforming.

In 1004, the network node receives, from the UE, a beamforming indication indicative of a request to switch to a set of beam weights for mitigation of a polarization imbalance associated with the at least one polarization imbalance measurement. As an example, the reception may be performed by one or more of the component 199, the transceiver(s) 1246, and/or the antenna 1280 in FIG. 12. FIG. 5 illustrates, in context of FIGS. 4 and 6-8, an example of a network node (e.g., the base station 504) receiving such an indication from a UE (e.g., the UE 502).

The UE 502 may be configured to switch (at 510) (e.g., 606, 608 in FIG. 6; 716 in FIG. 7; 814 in FIG. 8) to a set of beam weights for communication between the UE 502 and a network node (e.g., the base station 504) for mitigation of a polarization imbalance associated with the at least one polarization imbalance measurement. In aspects, the set of beam weights may include at least one of a first beam weight associated with a first polarization (e.g., a horizontal, a slant 45-degree polarization, etc.) or a second beam weight associated with a second polarization that is orthogonal to the first polarization (e.g., a vertical, a slant negative 45-degree polarization, etc.). In aspects, at least one of the first beam weight or the second beam weight may be associated with a UE beam of the UE 502 that corresponds to a respective network node beam of the network node (e.g., the base station 504 for the communication(s) 512). In aspects, to switch (at 510) (e.g., 606, 608 in FIG. 6; 716 in FIG. 7; 814 in FIG. 8) to the set of beam weights, the UE may be configured to calculate (e.g., 606 in FIG. 6), e.g., prior to the switch (at 510) (e.g., 606, 608 in FIG. 6; 716 in FIG. 7; 814 in FIG. 8) to the set of beam weights, one or more beam weights of the set of beam weights based on the at least one polarization imbalance measurement performed (at 508) (e.g., 809 in FIG. 8). In aspects, UE 502 may base the switch (at 510) (e.g., 606, 608 in FIG. 6; 716 in FIG. 7; 814 in FIG. 8) to the set of beam weights on a comparison of the at least one polarization imbalance measurement to an imbalance threshold condition, and/or on a UE 502 beamforming configuration indicative of switching to the set of beam weights from an initial set of beam weights associated with the signal transmission(s) 506 (e.g., 714 in FIG. 7).

Prior to, at least partially concurrently with, or subsequent to the switch (at 510) (e.g., 606, 608 in FIG. 6; 716 in FIG. 7; 814 in FIG. 8), the UE 502 may be configured to transmit, and the network node the (e.g., the base station 504) may be configured to receive, a beamforming indication (e.g., 610 in FIG. 6; 706 in FIG. 7; 810 in FIG. 8) indicative of a switch to and/or a request to switch to the set of beam weights for the mitigation of the polarization imbalance associated with the at least one polarization imbalance measurement. Based on the beamforming indication (e.g., 610 in FIG. 6; 706 in FIG. 7; 810 in FIG. 8), the UE 502 may be configured to receive, and the network node (e.g., the base station 504) may be configured to transmit, at least one of a TCI state change (e.g., 708 in FIG. 7; 812 in FIG. 8) or a beam switching indication (e.g., 710 in FIG. 7; 812 in FIG. 8) associated with the set of beam weights. Accordingly, the UE 502 may be configured to trigger to the network node (e.g., the base station 504, a gNB, etc.) a beamforming scheme switch (e.g., the switch (at 510) (e.g., 606, 608 in FIG. 6; 716 in FIG. 7; 814 in FIG. 8) to the set of beam weights) to enable the mitigation of polarization imbalance(s) due to the use of a case/cover (e.g., 410 in FIG. 4; 803 in FIG. 8) attachment with the UE 502. In aspects, the trigger signaling (e.g., the beamforming indication (e.g., 610 in FIG. 6; 706 in FIG. 7; 810 in FIG. 8) indicative of a switch to and/or a request to switch to the set of beam weights for the mitigation of the polarization imbalance associated with the at least one polarization imbalance measurement) may be based on an indication of an observed imbalance (e.g., the polarization imbalance measurement(s) performed (at 508) (e.g., 809 in FIG. 8). In some other aspects, the network node (e.g., the base station 504, a gNB, etc.) may configure the UE 502 with an allowed imbalance signal strength threshold and the UE 502 may be configured to indicate a beamforming switch by comparing observed polarization imbalance measurements (e.g., at 508) (e.g., 809 in FIG. 8) with the threshold.

In 1006, the network node communicates, with the network node, based on the set of beam weights. As an example, the communication(s) may be performed by one or more of the component 199, the transceiver(s) 1246, and/or the antenna 1280 in FIG. 12. FIG. 5 illustrates, in context of FIGS. 4 and 6-8, an example of a network node (e.g., the base station 504) so communicating such with a UE (e.g., the UE 502).

The UE 502 may be configured to communicate or receive/transmit the communication(s) 512, with the network node (e.g., the base station 504), based on the set of beam weights that are switched to (at 508) (e.g., 809 in FIG. 8). Likewise, the network node (e.g., the base station 504) may be configured to communicate or receive/transmit the communication(s) 512, with the UE 502, based on the set of beam weights that are switched to (at 508) (e.g., 809 in FIG. 8). In some aspects, UE 502 may be configured to provide/transmit, and the network node (e.g., the base station 504) may be configured to receive, reporting results (e.g., 718 in FIG. 7) associated with the switch (at 510) (e.g., 606, 608 in FIG. 6; 716 in FIG. 7; 814 in FIG. 8) to the set of beam weights. Such reporting results (e.g., 718 in FIG. 7) may be indicative of at least one of a polarization imbalance improvement, a two-layer spectral efficiency improvement, other key performance indicators (KPIs), the at least one polarization imbalance measurement, and/or the like.

Accordingly, in some aspects, if the UE 502 has balanced polarizations, or returns from unbalanced to balanced polarizations, based on the polarization imbalance measurement(s) performed (at 508) (e.g., 809 in FIG. 8), the UE 502 may continue to use an initial finite-sized codebook based beamforming scheme. In such aspects, if the UE 502 has imbalanced polarizations based on the polarization imbalance measurement(s) performed (at 508) (e.g., 809 in FIG. 8), the UE 502 may be configured to implement an improved beamforming scheme such as those based on adaptive/dynamic beam weights to mitigate imbalances. Thus, to mitigate imbalance across polarization layers, the UE 502 may be configured to switch (at 510) (e.g., 606, 608 in FIG. 6; 716 in FIG. 7; 814 in FIG. 8) to a beamforming scheme, e.g., to a set of beam weights, for the communication(s) 512 with the base station 504. This switch (at 510) (e.g., 606, 608 in FIG. 6; 716 in FIG. 7; 814 in FIG. 8) in beamforming scheme may include signaling from the UE 502 to the network node (e.g., the base station 504, a gNB, etc.) as network node-assisted beam synthesis for adaptive/dynamic beam weights may utilize reference signal configurations/grants, possible TCI state changes (e.g., 708 in FIG. 7; 812 in FIG. 8), UE 502 beam switching (e.g., 710 in FIG. 7; 812 in FIG. 8), and/or the like.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to perform at least one polarization imbalance measurement of at least one signal transmission, where the at least one polarization imbalance measurement is associated with an external covering or case of the UE. The component 198 may also be configured to switch to a set of beam weights for communication between the UE and a network node for mitigation of a polarization imbalance associated with the at least one polarization imbalance measurement. The component 198 may also be configured to communicate, with the network node, based on the set of beam weights. The component 198 may also be configured to calculate, prior to the switch to the set of beam weights, one or more beam weights of the set of beam weights based on the at least one polarization imbalance measurement. The component 198 may also be configured to transmit, to the network node, a beamforming indication indicative of the set of beam weights for the mitigation of the polarization imbalance associated with the at least one polarization imbalance measurement. The component 198 may also be configured to receive, from the network node and based on the beamforming indication, at least one of a TC) state change or a beam switching indication associated with the set of beam weights. The component 198 may also be configured to transmit, to the network node, a signal request for the at least one signal transmission associated with the at least one polarization imbalance measurement. The component 198 may also be configured to receive, from the network node, the at least one signal transmission based on the signal request. The component 198 may also be configured to provide, to the network node, reporting results associated with the switch to the set of beam weights, where the reporting results are indicative of at least one of a polarization imbalance improvement, a two-layer spectral efficiency improvement, or the at least one polarization imbalance measurement. The component 198 may be further configured to perform any of the aspects described in connection with the flowcharts in any of FIGS. 9, 10 and/or any of the aspects performed by a UE for any of FIGS. 4-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for performing at least one polarization imbalance measurement of at least one signal transmission, where the at least one polarization imbalance measurement is associated with an external covering or case of the UE. In the configuration, the apparatus 1104, and in particular the cellular baseband processor(s) 1124 and/or the application processor(s) 1106, may include means for switching to a set of beam weights for communication between the UE and a network node for mitigation of a polarization imbalance associated with the at least one polarization imbalance measurement. In the configuration, the apparatus 1104, and in particular the cellular baseband processor(s) 1124 and/or the application processor(s) 1106, may include means for communicating, with the network node, based on the set of beam weights. In one configuration, the apparatus 1104, and in particular the cellular baseband processor(s) 1124 and/or the application processor(s) 1106, may include means for calculating, prior to the switch to the set of beam weights, one or more beam weights of the set of beam weights based on the at least one polarization imbalance measurement. In one configuration, the apparatus 1104, and in particular the cellular baseband processor(s) 1124 and/or the application processor(s) 1106, may include means for transmitting, to the network node, a beamforming indication indicative of the set of beam weights for the mitigation of the polarization imbalance associated with the at least one polarization imbalance measurement. In one configuration, the apparatus 1104, and in particular the cellular baseband processor(s) 1124 and/or the application processor(s) 1106, may include means for receiving, from the network node and based on the beamforming indication, at least one of a TC) state change or a beam switching indication associated with the set of beam weights. In one configuration, the apparatus 1104, and in particular the cellular baseband processor(s) 1124 and/or the application processor(s) 1106, may include means for transmitting, to the network node, a signal request for the at least one signal transmission associated with the at least one polarization imbalance measurement. In one configuration, the apparatus 1104, and in particular the cellular baseband processor(s) 1124 and/or the application processor(s) 1106, may include means for receiving, from the network node, the at least one signal transmission based on the signal request. In one configuration, the apparatus 1104, and in particular the cellular baseband processor(s) 1124 and/or the application processor(s) 1106, may include means for providing, to the network node, reporting results associated with the switch to the set of beam weights, where the reporting results are indicative of at least one of a polarization imbalance improvement, a two-layer spectral efficiency improvement, or the at least one polarization imbalance measurement. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, at least one signal transmission for at least one polarization imbalance measurement associated with an external covering or case of the UE. The component 199 may also be configured to receive, from the UE, a beamforming indication indicative of a switch to a set of beam weights for mitigation of a polarization imbalance associated with the at least one polarization imbalance measurement. The component 199 may also be configured to communicate, with the UE, based on the set of beam weights. The component 199 may also be configured to transmit, for the UE and based on the beamforming indication, at least one of a TCI state change or a beam switching indication associated with the set of beam weights. The component 199 may also be configured to receive, from the UE, a signal request for the at least one signal transmission associated with the at least one polarization imbalance measurement, where transmitting the at least one signal transmission is based on the signal request, where the at least one signal transmission is associated with an initial set of beam weights based on a finite codebook. The component 199 may also be configured to receive, from the UE, reporting results associated with the switch to the set of beam weights, where the reporting results are indicative of at least one of a polarization imbalance improvement, a two-layer spectral efficiency improvement, or the at least one polarization imbalance measurement. The component 199 may be further configured to perform any of the aspects described in connection with the flowcharts in any of FIGS. 9, 10 and/or any of the aspects performed by a network node, base station, gNB, etc., for any of FIGS. 4-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting, for a UE, at least one signal transmission for at least one polarization imbalance measurement associated with an external covering or case of the UE. In the configuration, the network entity 1202 may include means for receiving, from the UE, a beamforming indication indicative of a switch to a set of beam weights for mitigation of a polarization imbalance associated with the at least one polarization imbalance measurement. In the configuration, the network entity 1202 may include means for communicating, with the UE, based on the set of beam weights. In one configuration, the network entity 1202 may include means for transmitting, for the UE and based on the beamforming indication, at least one of a TCI state change or a beam switching indication associated with the set of beam weights. In one configuration, the network entity 1202 may include means for receiving, from the UE, a signal request for the at least one signal transmission associated with the at least one polarization imbalance measurement, where transmitting the at least one signal transmission is based on the signal request, where the at least one signal transmission is associated with an initial set of beam weights based on a finite codebook. In one configuration, the network entity 1202 may include means for receiving, from the UE, reporting results associated with the switch to the set of beam weights, where the reporting results are indicative of at least one of a polarization imbalance improvement, a two-layer spectral efficiency improvement, or the at least one polarization imbalance measurement. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A network node and a UE in a wireless communication network may communicate using beams generated by respective antennas through beamforming. Beams may be formed based on beam weights that act as parameters for phase shifters and amplitude controls of beams. Beam weights may be represented as codebooks, such as fixed-size or finite codebooks, which are small in size and easily stored/implemented. However, the use of UE cases and/or covers may affect the polarization of transmissions from antennas that would otherwise communicate nominally using beam weights of fixed-size or finite codebooks. Moreover, closing link budgets at FR2 (24.25 GHz-52.6 GHz)/FR3 (7.125 GHZ-24.25 GHz) and beyond frequencies may be accomplished using beamforming at the microwave (RF/IF) level. Analog beamforming codebooks for these frequencies may be designed based on electric field simulations/measurements without use of any UE cases/covers. Such designs may incorporate the impact of UE housing on performance, yet in practice, UEs may be used with a case/cover for cosmetic or practical reasons. These cases/covers cannot be incorporated in codebook design as they are user-specific and can change with time. Further, many variants of UE cases/covers are possible based on different manufacturers (e.g., not all cases/covers are manufactured by or based on UE OEM advice), cost, material composition/mix, thickness of material, etc. When dual-polarized antennas are used in FR2 implementations to double data rates relative to sub-6 GHz systems, the signal strength balance between the two polarizations may be distorted due to the use of a UE case/cover depending on material properties, frequency, angle of interest of the steered beam, and/or the like.

The aspects herein for beam management triggers due to polarization imbalance with UE cases/covers provide for measurements of polarization imbalances due to UE cases/covers to be performed on reference signals provided by a network node. A UE may be configured to switch from an initial set of beam weights (e.g., a finite/fixed codebook) to a set of beam weights for communication between the UE and a network node for mitigation of the polarization imbalances that are measured. Aspects herein provide beam management intervention/mitigation to minimize polarization imbalances by measuring polarization imbalances associated with a UE case/cover in operating conditions, and also provide beam management intervention/mitigation across any type of UE case/cover regardless of manufacturer, composition, carrier frequency range of operation, beam properties, and/or the like, by adaptively switching a set of beam weights based on polarization imbalance measurements.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: performing at least one polarization imbalance measurement of at least one signal transmission, wherein the at least one polarization imbalance measurement is associated with an external covering or case of the UE; switching to a set of beam weights for communication between the UE and a network node for mitigation of a polarization imbalance associated with the at least one polarization imbalance measurement; and communicating, with the network node, based on the set of beam weights.

Aspect 2 is the method of aspect 1, wherein switching to the set of beam weights comprises: calculating, prior to the switch to the set of beam weights, one or more beam weights of the set of beam weights based on the at least one polarization imbalance measurement.

Aspect 3 is the method of any of aspects 1 and 2, further comprising: transmitting, to the network node, a beamforming indication indicative of the set of beam weights for the mitigation of the polarization imbalance associated with the at least one polarization imbalance measurement.

Aspect 4 is the method of aspect 3, further comprising: receiving, from the network node and based on the beamforming indication, at least one of a transmission configuration indicator (TCI) state change or a beam switching indication associated with the set of beam weights.

Aspect 5 is the method of any of aspects 1 to 4, wherein the set of beam weights includes at least one of a first beam weight associated with a first polarization or a second beam weight associated with a second polarization that is orthogonal to the first polarization.

Aspect 6 is the method of aspect 5, wherein at least one of the first beam weight or the second beam weight is associated with a UE beam that corresponds to a respective network node beam for the communication.

Aspect 7 is the method of aspect 6, wherein the at least one signal transmission includes one or more reference signals, wherein the at least one polarization imbalance measurement is associated with a signal strength difference across the first polarization and the second polarization of the one or more reference signals.

Aspect 8 is the method of any of aspects 1 to 7, wherein the at least one polarization imbalance measurement is based on at least one of a material composition of the external covering or case, a dielectric constant of the external covering or case, a material thickness of the external covering or case, a carrier frequency range of operation, a set of housing properties of the UE, a UE antenna array dimension, inter-antenna element spacings at the UE, one or more steered beam properties, or a direction of interest associated with beamforming.

Aspect 9 is the method of any of aspects 1 to 8, wherein switching to the set of beam weights is based on at least one of: a comparison of the at least one polarization imbalance measurement to an imbalance threshold condition, or a UE beamforming configuration indicative of switching to the set of beam weights from an initial set of beam weights associated with the at least one signal transmission.

Aspect 10 is the method of any of aspects 1 to 9, further comprising: transmitting, to the network node, a signal request for the at least one signal transmission associated with the at least one polarization imbalance measurement; and receiving, from the network node, the at least one signal transmission based on the signal request.

Aspect 11 is the method of aspect 10, wherein the at least one signal transmission is associated with an initial set of beam weights based on a finite codebook.

Aspect 12 is the method of any of aspects 1 to 11, further comprising: providing, to the network node, reporting results associated with the switch to the set of beam weights, wherein the reporting results are indicative of at least one of a polarization imbalance improvement, a two-layer spectral efficiency improvement, or the at least one polarization imbalance measurement.

Aspect 13 is a method of wireless communication at a network node, comprising: transmitting, for a user equipment (UE), at least one signal transmission for at least one polarization imbalance measurement associated with an external covering or case of the UE; receiving, from the UE, a beamforming indication indicative of a request to switch to a set of beam weights for mitigation of a polarization imbalance associated with the at least one polarization imbalance measurement; and communicating, with the UE, based on the set of beam weights.

Aspect 14 is the method of claim 13, further comprising: transmitting, for the UE and based on the beamforming indication, at least one of a transmission configuration indicator (TCI) state change or a beam switching indication associated with the set of beam weights.

Aspect 15 is the method of any of aspects 13 and 14, wherein the set of beam weights includes at least one of a first beam weight associated with a first polarization or a second beam weight associated with a second polarization that is orthogonal to the first polarization.

Aspect 16 is the method of aspect 15, wherein at least one of the first beam weight or the second beam weight is associated with a UE beam that corresponds to a respective network node beam for the communication; wherein the at least one signal transmission includes one or more reference signals, wherein the at least one polarization imbalance measurement is associated with a signal strength difference across the first polarization and the second polarization of the one or more reference signals; or wherein the at least one polarization imbalance measurement is based on at least one of a material composition of the external covering or case, a dielectric constant of the external covering or case, a material thickness of the external covering or case, a carrier frequency range of operation, a set of housing properties of the UE, a UE antenna array dimension, inter-antenna element spacings at the UE, one or more steered beam properties, or a direction of interest associated with beamforming.

Aspect 17 is the method of any of aspects 13 to 16, wherein the switch to the set of beam weights is based on at least one of: a comparison of the at least one polarization imbalance measurement to an imbalance threshold condition, or a UE beamforming configuration indicative of switching to the set of beam weights from an initial set of beam weights associated with the at least one signal transmission.

Aspect 18 is the method of any of aspects 13 to 17, further comprising: receiving, from the UE, a signal request for the at least one signal transmission associated with the at least one polarization imbalance measurement, wherein transmitting the at least one signal transmission is based on the signal request, wherein the at least one signal transmission is associated with an initial set of beam weights based on a finite codebook.

Aspect 19 is the method of any of aspects 13 to 18, further comprising: receiving, from the UE, reporting results associated with the switch to the set of beam weights, wherein the reporting results are indicative of at least one of a polarization imbalance improvement, a two-layer spectral efficiency improvement, or the at least one polarization imbalance measurement.

Aspect 20 is an apparatus for wireless communication at a user equipment (UE), comprising: at least one memory; and at least one processor coupled to the at least one memory, the at least one processor, individually or in any combination, is configured to perform the method of any of aspects 1 to 12.

Aspect 21 is an apparatus for wireless communication at a user equipment (UE), comprising means for performing each step in the method of any of aspects 1 to 12.

Aspect 22 is the apparatus of any of aspects 20 and 21, further comprising a transceiver configured to receive or to transmit in association with the method of any of aspects 1 to 12.

Aspect 23 is a computer-readable medium storing computer executable code at a user equipment (UE), the code when executed by at least one processor causes the at least one processor to perform the method of any of aspects 1 to 12.

Aspect 24 is an apparatus for wireless communication at a network node, comprising: at least one memory; and at least one processor coupled to the at least one memory, the at least one processor, individually or in any combination, is configured to perform the method of any of aspects 13 to 19.

Aspect 25 is an apparatus for wireless communication at a network node, comprising means for performing each step in the method of any of aspects 13 to 19.

Aspect 26 is the apparatus of any of aspects 24 and 25, further comprising a transceiver configured to receive or to transmit in association with the method of any of aspects 13 to 19.

Aspect 27 is a computer-readable medium (e.g., a non-transitory computer-readable medium) storing computer executable code at a network node, the code when executed by at least one processor causes the at least one processor to perform the method of any of aspects 13 to 19.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
perform at least one polarization imbalance measurement of at least one signal transmission, wherein the at least one polarization imbalance measurement is associated with an external covering or case of the UE;
switch to a set of beam weights for communication between the UE and a network node for mitigation of a polarization imbalance associated with the at least one polarization imbalance measurement; and
communicate, with the network node, based on the set of beam weights.

2. The apparatus of claim 1, wherein to switch to the set of beam weights, the at least one processor, individually or in any combination, is configured to:
calculate, prior to the switch to the set of beam weights, one or more beam weights of the set of beam weights based on the at least one polarization imbalance measurement.

3. The apparatus of claim 1, wherein the at least one processor, individually or in any combination, is further configured to:
transmit, to the network node, a beamforming indication indicative of the set of beam weights for the mitigation of the polarization imbalance associated with the at least one polarization imbalance measurement.

4. The apparatus of claim 3, wherein the at least one processor, individually or in any combination, is further configured to:
receive, from the network node and based on the beamforming indication, at least one of a transmission configuration indicator (TCI) state change or a beam switching indication associated with the set of beam weights.

5. The apparatus of claim 1, wherein the set of beam weights includes at least one of a first beam weight associated with a first polarization or a second beam weight associated with a second polarization that is orthogonal to the first polarization.

6. The apparatus of claim 5, wherein at least one of the first beam weight or the second beam weight is associated with a UE beam that corresponds to a respective network node beam for the communication.

7. The apparatus of claim 6, wherein the at least one signal transmission includes one or more reference signals, wherein the at least one polarization imbalance measurement is associated with a signal strength difference across the first polarization and the second polarization of the one or more reference signals.

8. The apparatus of claim 1, wherein the at least one polarization imbalance measurement is based on at least one of a material composition of the external covering or case, a dielectric constant of the external covering or case, a material thickness of the external covering or case, a carrier frequency range of operation, a set of housing properties of the UE, a UE antenna array dimension, inter-antenna element spacings at the UE, one or more steered beam properties, or a direction of interest associated with beamforming.

9. The apparatus of claim 1, wherein to switch to the set of beam weights, the at least one processor, individually or in any combination, is configured to switch to the set of beam weights based on at least one of:
a comparison of the at least one polarization imbalance measurement to an imbalance threshold condition, or
a UE beamforming configuration indicative of switching to the set of beam weights from an initial set of beam weights associated with the at least one signal transmission.

10. The apparatus of claim 1, wherein the at least one processor, individually or in any combination, is further configured to:
transmit, to the network node, a signal request for the at least one signal transmission associated with the at least one polarization imbalance measurement; and
receive, from the network node, the at least one signal transmission based on the signal request.

11. The apparatus of claim 10, wherein the at least one signal transmission is associated with an initial set of beam weights based on a finite codebook.

12. The apparatus of claim 1, further comprising a transceiver coupled to the at least one processor, wherein the at least one processor, individually or in any combination, is further configured to:
provide, to the network node via the transceiver, reporting results associated with the switch to the set of beam weights, wherein the reporting results are indicative of at least one of a polarization imbalance improvement, a two-layer spectral efficiency improvement, or the at least one polarization imbalance measurement.

13. An apparatus for wireless communication at a network node, comprising:
at least one memory; and
at least one processor coupled to the at least one memory and, based at least in part on information stored in the at least one memory, the at least one processor, individually or in any combination, is configured to:
transmit, for a user equipment (UE), at least one signal transmission for at least one polarization imbalance measurement associated with an external covering or case of the UE;
receive, from the UE, a beamforming indication indicative of a request to switch to a set of beam weights for mitigation of a polarization imbalance associated with the at least one polarization imbalance measurement; and
communicate, with the UE, based on the set of beam weights.

14. The apparatus of claim 13, wherein the at least one processor, individually or in any combination, is further configured to:
transmit, for the UE and based on the beamforming indication, at least one of a transmission configuration indicator (TCI) state change or a beam switching indication associated with the set of beam weights.

15. The apparatus of claim 13, wherein the set of beam weights includes at least one of a first beam weight associated with a first polarization or a second beam weight associated with a second polarization that is orthogonal to the first polarization.

16. The apparatus of claim 15, wherein at least one of the first beam weight or the second beam weight is associated with a UE beam that corresponds to a respective network node beam for the communication;
wherein the at least one signal transmission includes one or more reference signals, wherein the at least one polarization imbalance measurement is associated with a signal strength difference across the first polarization and the second polarization of the one or more reference signals; or
wherein the at least one polarization imbalance measurement is based on at least one of a material composition of the external covering or case, a dielectric constant of the external covering or case, a material thickness of the external covering or case, a carrier frequency range of operation, a set of housing properties of the UE, a UE antenna array dimension, inter-antenna element spacings at the UE, one or more steered beam properties, or a direction of interest associated with beamforming.

17. The apparatus of claim 13, wherein to switch to the set of beam weights, the at least one processor, individually or in any combination, is configured to switch to the set of beam weights based on at least one of:
a comparison of the at least one polarization imbalance measurement to an imbalance threshold condition, or
a UE beamforming configuration indicative of switching to the set of beam weights from an initial set of beam weights associated with the at least one signal transmission.

18. The apparatus of claim 13, wherein the at least one processor, individually or in any combination, is further configured to:
receive, from the UE, a signal request for the at least one signal transmission associated with the at least one polarization imbalance measurement, wherein transmitting the at least one signal transmission is based on the signal request, wherein the at least one signal transmission is associated with an initial set of beam weights based on a finite codebook.

19. The apparatus of claim 13, further comprising a transceiver coupled to the at least one processor, wherein the at least one processor, individually or in any combination, is further configured to:
receive, from the UE via the transceiver, reporting results associated with the switch to the set of beam weights, wherein the reporting results are indicative of at least one of a polarization imbalance improvement, a two-layer spectral efficiency improvement, or the at least one polarization imbalance measurement.

20. A method of wireless communication at a user equipment (UE), comprising:
performing at least one polarization imbalance measurement of at least one signal transmission, wherein the at least one polarization imbalance measurement is associated with an external covering or case of the UE;
switching to a set of beam weights for communication between the UE and a network node for mitigation of a polarization imbalance associated with the at least one polarization imbalance measurement; and
communicating, with the network node, based on the set of beam weights.
